(19) United States
(12) Patent Application Publication
(10) Pub. No.: US 2021/0133235 A1
(43) Pub. Date: May 6, 2021

(54) SYSTEMS AND METHODS FOR MEDIA CONTENT ITEM SELECTION

(71) Applicant: Spotify AB, Stockholm (SE)

(72) Inventor: Mikael Simon David Klamra, Stockholm (SE)

(21) Appl. No.: 16/669,315

(22) Filed: Oct. 30, 2019

(51) Int. Cl. G06F 16/635; G06F 16/638; G06F 1/16

(52) U.S. Cl. CPC G06F 16/636; G06F 16/637; G06F 1/163; G06F 16/639

(57) ABSTRACT

An electronic device determines, based on a first media content item, a first list of media content items. The electronic device filters the first list of media content items, based on data associated with a user, to generate a second list of media content items. Media content items in the second list are associated with respective attributes. The device determines a value of one or more physical parameters of the user and generates a ranked list of media content items based on the second list of media content items, including determining a degree of correlation between the respective attributes of the respective media content items of the second list of media content items, and the value of the one or more physical parameters of the user. The device provides, using the ranked list of media content items, a second media content item from the second list to the user.

### TECHNICAL FIELD

The disclosed embodiments relate generally to media playback, and, in particular, to selecting a media content item based on physical parameters of a user.

### BACKGROUND

Access to electronic media, such as music and video content, has expanded dramatically over time. As a departure from physical media, media content providers stream media to electronic devices across wireless networks, improving the convenience with which users can digest and experience such content.

When a user is consuming content, additional content is recommended to the user based on the user's personal preferences. Content providers provide greater ease and seamlessness between the presentation of content items when the content providers automatically recommend and provide additional content to the user without requiring user input. In order to provide more personalized content for users, media content providers need to be able to identify and select content that matches a user's current state.

### SUMMARY

There is a need for systems and methods of selecting media content to present to a user based on the current media content that is presented to the user and current physical parameters of the user.

To that end, a media content provider selects media content to provide to a user based on information indicative of the user's current mood (e.g., as indicated by physical parameters of the user, such as the user's blood pressure, pulse, body temperature, facial information and/or contextual information such as the air temperature surrounding the user). The current mood of the user is determined, for example, based on a physical attribute of the user that is measured (e.g., by a wearable device). The content item may be determined using a combination of factors such as the content item's similarity to currently playing or recently played content, the user's personal tastes, and/or the user's current mood.

For example, the system determines one or more media content items that are similar to a current media content item being played by the user. The system filters the list of similar content items to determine which of the content item(s) match the user's personal tastes (e.g., determined from the user's playback history and user profile). After filtering the list, the system uses information indicative of the current mood of the user to select a media content item, from the filtered list, that is associated with a mood that most closely matches the current mood of the user. For example, the system ranks the content items in the filtered list based on which content items are tagged with a mood that matches a current mood of the user. The ranked content items are used to determine a content item to provide to the user.

In accordance with some embodiments, a method is performed at a first electronic device. The first electronic device has one or more processors and memory storing instructions for execution by the one or more processors. The method includes determining, based on a first media content item, a first list of media content items. The media content items in the first list meet similarity criteria that indicate similarity between the respective media content items of the first list of media content items and the first media content item. The method further includes filtering the first list of media content items, based on data associated with a user, to generate a second list of media content items. The respective media content items in the second list of media content items are associated with respective attributes. The method includes determining a value of one or more physical parameters of the user. The method further includes generating a ranked list of media content items based on the second list of media content items, including determining a degree of correlation between the respective attributes of the respective media content items of the second list of media content items, and the value of the one or more physical parameters of the user. The method includes providing, using the ranked list of media content items, a second media content item from the second list of media content items to the user.

In some embodiments, determining the first list of media content items is performed while providing the first media content item to the user.

In some embodiments, determining the first list of media content items is performed after provision of the first media content item to the user is completed.

In some embodiments, the one or more physical parameters of the user comprises one or more of blood pressure, pulse, body temperature, and air temperature.

In some embodiments, the value of the one or more physical parameters is measured using a wearable device associated with the user.

In some embodiments, generating the ranked list of media content items includes associating a respective physical parameter value of the values of the one or more physical parameters with a respective media content item of the second list of media content items.

In some embodiments, determining the first list of media content items comprises determining a degree of similarity between the first media content item and the respective media content items in the first list.

In some embodiments, the data associated with the user comprises account information associated with the user.

In some embodiments, the data associated with the user comprises a playback history of the user.

In some embodiments, the data associated with the user comprises an indication of an input provided by the user.

In some embodiments, generating the ranked list of media content items comprises determining a number of times a respective media content item has been played, within a predefined period of time, by at least a subset of users of the media-providing service.

In some embodiments, generating the ranked list of media content items comprises determining a degree of similarity between the first media content item and respective media content items in the second list.

In some embodiments, a respective media content item in the second list of media content items is associated with one or more values indicating one or more emotional tags.

In some embodiments, the method further includes, after providing the second media content item to the user, determining, based on the second media content item, a third list of media content items. The media content items in the third list meet similarity criteria that indicate similarity between the respective media content items of the third list of media content items and the second media content item. In some embodiments, the method further includes filtering the third list of media content items, based on data associated with the user, to generate a fourth list of media content items. The respective media content items in the fourth list of content items are associated with respective attributes. In some embodiments, the method further includes determining a value of one or more physical parameters of the user and generating a ranked list of media content items based on the fourth list of media content items, including determining a degree of correlation between the respective attributes of the respective media content items of the fourth list of media content items, and the value of the one or more physical parameters of the user. In some embodiments, the method includes providing a third media content item based on an updated value of the one or more physical parameters.

In some embodiments, the second media content item is the top-ranked media content item in the ranked list.

In accordance with some embodiments, a first electronic device (e.g., a server system, a client device, etc.) includes one or more processors and memory storing one or more programs configured to be executed by the one or more processors. The one or more programs include instructions for determining, based on a first media content item, a first list of media content items. The media content items in the first list meet similarity criteria that indicate similarity between the respective media content items of the first list of media content items and the first media content item. The one or more programs further include instructions for filtering the first list of media content items, based on data associated with a user, to generate a second list of media content items. The respective media content items in the second list of media content items are associated with respective attributes. The one or more programs include instructions for determining a value of one or more physical parameters of the user. The one or more programs further include instructions for generating a ranked list of media content items based on the second list of media content items, including determining a degree of correlation between the respective attributes of the respective media content items of the second list of media content items, and the value of the one or more physical parameters of the user. The one or more programs include instructions for providing, using the ranked list of media content items, a second media content item from the second list of media content items to the user.

In accordance with some embodiments, a computer-readable storage medium has stored therein instructions that, when executed by an electronic device, cause the first electronic device to determine, based on a first media content item, a first list of media content items. The media content items in the first list meet similarity criteria that indicate similarity between the respective media content items of the first list of media content items and the first media content item. The instructions further cause the first electronic device to filter the first list of media content items, based on data associated with the user, to generate a second list of media content items. The respective media content items in the second list of media content items are associated with respective attributes. The instructions further cause the first electronic device to determine a value of one or more physical parameters of the user. The instructions further cause the first electronic device to generate a ranked list of media content items based on the second list of media content items, including determining a degree of correlation between the respective attributes of the respective media content items of the second list of media content items, and the value of the one or more physical parameters of the user. The instructions further cause the first electronic device to provide, using the ranked list of media content items, a second media content item from the second list of media content items to the user.

Thus, systems are provided with improved methods for providing information associated with media content items based on a proxy media content item.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings and specification.

FIG. 1 is a block diagram illustrating a media content delivery system, in accordance with some embodiments.

FIG. 2 is a block diagram illustrating a client device, in accordance with some embodiments.

FIG. 3 is a block diagram illustrating a media content server, in accordance with some embodiments.

FIG. 4 is a block diagram illustrating a method of using user data and physical parameters to select a media content item, in accordance with some embodiments.

FIGS. 5A-5C are flow diagrams illustrating a method of providing a media content item, in accordance with some embodiments.

### DETAILED DESCRIPTION

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first electronic device could be termed a second electronic device, and, similarly, a second electronic device could be termed a first electronic device, without departing from the scope of the various described embodiments. The first electronic device and the second electronic device are both electronic devices, but they are not the same electronic device.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

Embodiments described herein relate to providing a media content item to a user based on a physical parameter of the user (e.g., biological parameters and/or parameters corresponding to ambient conditions of a current environment of the user). For example, a wearable device collects data for the user, and an electronic device uses the data collected by the wearable device to determine a current state of the user, such as a mood of the user. The electronic device, based on the current state of the user, selects a media content item for the user and presents the media content item to the user.

Automatically selecting a media content item based on physical parameters that reflect a user's current state increases the efficiency of the human-machine interface by requiring fewer inputs by the user to select a next media content item. By automatically selecting and providing a media content item for the user, the processing power required by the electronic device to receive and process user inputs to search for and select a media content item is decreased.

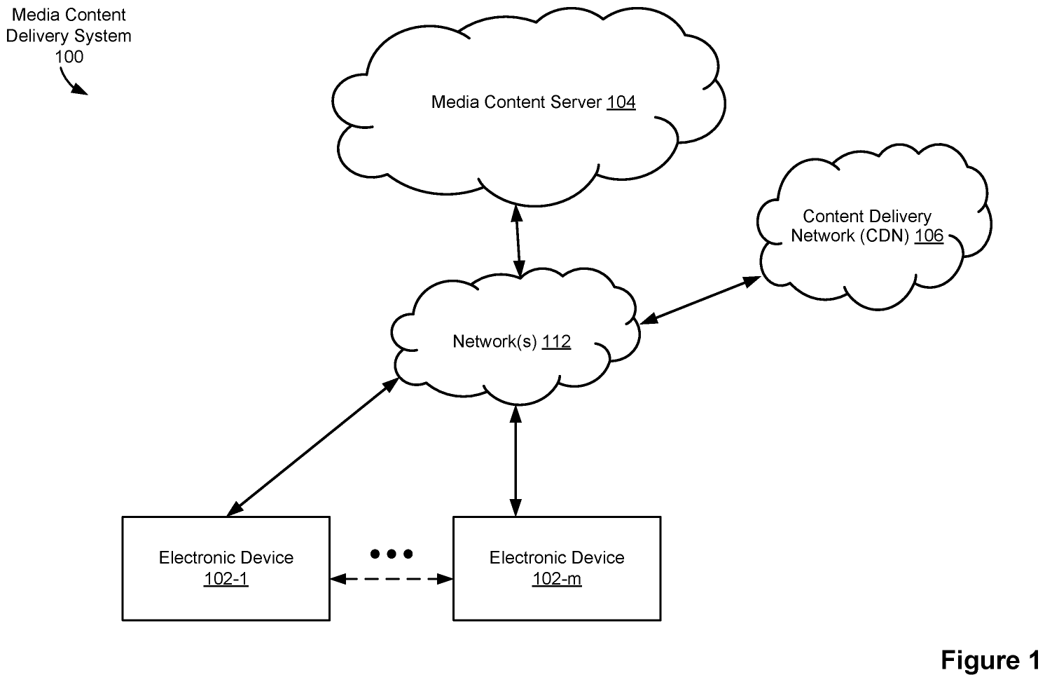

FIG. 1 is a block diagram illustrating a media content delivery system 100, in accordance with some embodiments. The media content delivery system 100 includes one or more electronic devices 102 (e.g., electronic device 102-1 to electronic device 102-m, where m is an integer greater than one), one or more media content servers 104, and/or one or more content delivery networks (CDNs) 106. The one or more media content servers 104 are associated with (e.g., at least partially compose) a media-providing service. The one or more CDNs 106 store and/or provide one or more content items (e.g., to electronic devices 102). In some embodiments, the one or more CDNs 106 are associated with the media-providing service. In some embodiments, the CDNs 106 are included in the media content servers 104. One or more networks 112 communicably couple the components of the media content delivery system 100. In some embodiments, the one or more networks 112 include public communication networks, private communication networks, or a combination of both public and private communication networks. For example, the one or more networks 112 can be any network (or combination of networks) such as the Internet, other wide area networks (WAN), local area networks (LAN), virtual private networks (VPN), metropolitan area networks (MAN), peer-to-peer networks, and/or ad-hoc connections.

In some embodiments, an electronic device 102 is associated with one or more users. In some embodiments, an electronic device 102 is a personal computer, mobile electronic device, wearable computing device, laptop computer, tablet computer, mobile phone, feature phone, smart phone, digital media player, a speaker, television (TV), digital versatile disk (DVD) player, and/or any other electronic device capable of presenting media content (e.g., controlling playback of media items, such as music tracks, videos, etc.). Electronic devices 102 may connect to each other wirelessly and/or through a wired connection (e.g., directly through an interface, such as an HDMI interface). In some embodiments, an electronic device 102 is a headless client. In some embodiments, electronic devices 102-1 and 102-m are the same type of device (e.g., electronic device 102-1 and electronic device 102-m are both speakers). Alternatively, electronic device 102-1 and electronic device 102-m include two or more different types of devices.

In some embodiments, the electronic device (e.g., a wearable computing device) includes sensors for measuring physical parameters (e.g., of the user). For example, the electronic device includes one or more of: a heart rate sensor (e.g., an electrocardiography sensor and/or a photoplethysmography sensor), one or more thermometers (e.g., to measure a temperature of the user and/or an ambient temperature), a pulse oximeter, a chest strap (e.g., to measure heart rate and/or a respiratory rate), a moisture sensor (e.g., to measure moisture on a user's skin), and a blood pressure monitor.

In some embodiments, electronic devices 102-1 and 102-m send and receive media-control information through network(s) 112. For example, electronic devices 102-1 and 102-m send media control requests (e.g., requests to play music, movies, videos, or other media items, or playlists thereof) to media content server 104 through network(s) 112. Additionally, in some embodiments, electronic devices 102-1 and 102-m also send indications of media content items to media content server 104 through network(s) 112. In some embodiments, the media content items are uploaded to electronic devices 102-1 and 102-m before the electronic devices forward the media content items to media content server 104.

In some embodiments, electronic device 102-1 communicates directly with electronic device 102-m (e.g., as illustrated by the dotted-line arrow), or any other electronic device 102. As illustrated in FIG. 1, electronic device 102-1 is able to communicate directly (e.g., through a wired connection and/or through a short-range wireless signal, such as those associated with personal-area-network (e.g., BLUETOOTH/BLE) communication technologies, radio-frequency-based near-field communication technologies, infrared communication technologies, etc.) with electronic device 102-m. In some embodiments, electronic device 102-1 communicates with electronic device 102-m through network(s) 112. In some embodiments, electronic device 102-1 uses the direct connection with electronic device 102-m to stream content (e.g., data for media items) for playback on the electronic device 102-m.

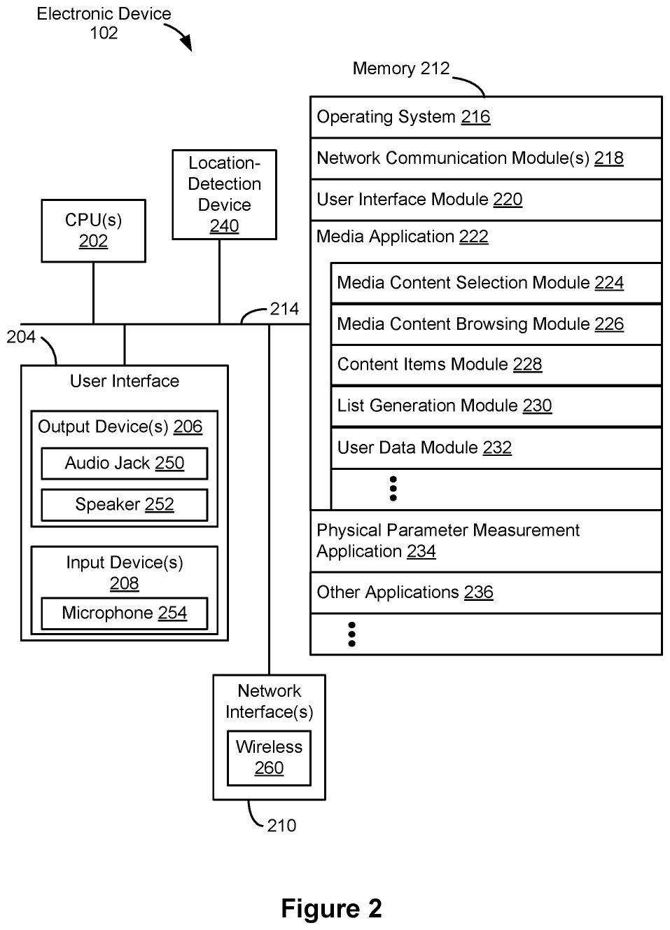

In some embodiments, electronic device 102-1 and/or electronic device 102-m include a media application 222 (FIG. 2) that allows a respective user of the respective electronic device to upload (e.g., to media content server 104), browse, request (e.g., for playback at the electronic device 102), and/or present media content (e.g., control playback of music tracks, videos, etc.). In some embodiments, one or more media content items are stored locally by an electronic device 102 (e.g., in memory 212 of the electronic device 102, FIG. 2). In some embodiments, one or more media content items are received by an electronic device 102 in a data stream (e.g., from the CDN 106 and/or from the media content server 104). In some embodiments, the electronic device(s) 102 are capable of receiving media content (e.g., from the CDN 106) and presenting the received media content. For example, electronic device 102-1 may be a component of a network-connected audio/video system (e.g., a home entertainment system, a radio/alarm clock with a digital display, and/or an infotainment system of a vehicle). In some embodiments, the CDN 106 sends media content to the electronic device(s) 102.

In some embodiments, the CDN 106 stores and provides media content (e.g., media content requested by the media application 222 of electronic device 102) to electronic device 102 via the network(s) 112. Content (also referred to herein as “media items,” “media content items,” and “content items”) is received, stored, and/or served by the CDN 106. In some embodiments, content includes audio (e.g., music, spoken word, podcasts, etc.), video (e.g., short-form videos, music videos, television shows, movies, clips, previews, etc.), text (e.g., articles, blog posts, emails, etc.), image data (e.g., image files, photographs, drawings, renderings, etc.), games (e.g., 2- or 3-dimensional graphics-based computer games, etc.), or any combination of content types (e.g., web pages that include any combination of the foregoing types of content or other content not explicitly listed). In some embodiments, content includes one or more audio media items (also referred to herein as “audio items,” “tracks,” and/or “audio tracks”).

In some embodiments, media content server 104 receives media requests (e.g., commands) from electronic devices 102. In some embodiments, media content server 104 and/or CDN 106 stores one or more playlists (e.g., information indicating a set of media content items). For example, a playlist is a set of media content items defined by a user and/or defined by an editor associated with a media-providing service. The description of the media content server 104 as a “server” is intended as a functional description of the devices, systems, processor cores, and/or other components that provide the functionality attributed to the media content server 104. It will be understood that the media content server 104 may be a single server computer, or may be multiple server computers. Moreover, the media content server 104 may be coupled to CDN 106 and/or other servers and/or server systems, or other devices, such as other client devices, databases, content delivery networks (e.g., peer-to-peer networks), network caches, and the like. In some embodiments, the media content server 104 is implemented by multiple computing devices working together to perform the actions of a server system (e.g., cloud computing).

FIG. 2 is a block diagram illustrating an electronic device 102 (e.g., electronic device 102-1 and/or electronic device 102-m, FIG. 1), in accordance with some embodiments. The electronic device 102 includes one or more central processing units (CPU(s), i.e., processors or cores) 202, one or more network (or other communications) interfaces 210, memory 212, and one or more communication buses 214 for interconnecting these components. The communication buses 214 optionally include circuitry (sometimes called a chipset) that interconnects and controls communications between system components.

In some embodiments, the electronic device 102 includes a user interface 204, including output device(s) 206 and/or input device(s) 208. In some embodiments, the input devices 208 include a keyboard, mouse, or track pad. Alternatively, or in addition, in some embodiments, the user interface 204 includes a display device that includes a touch-sensitive surface, in which case the display device is a touch-sensitive display. In electronic devices that have a touch-sensitive display, a physical keyboard is optional (e.g., a soft keyboard may be displayed when keyboard entry is needed). In some embodiments, the output devices (e.g., output device(s) 206) include a speaker 252 (e.g., speakerphone device) and/or an audio jack 250 (or other physical output connection port) for connecting to speakers, earphones, headphones, or other external listening devices. Furthermore, some electronic devices 102 use a microphone and voice recognition device to supplement or replace the keyboard. Optionally, the electronic device 102 includes an audio input device (e.g., a microphone 254) to capture audio (e.g., speech from a user).

Optionally, the electronic device 102 includes a location-detection device 240, such as a global navigation satellite system (GNSS) (e.g., GPS (global positioning system), GLONASS, Galileo, BeiDou) or other geo-location receiver, and/or location-detection software for determining the location of the electronic device 102 (e.g., module for finding a position of the electronic device 102 using trilateration of measured signal strengths for nearby devices).

In some embodiments, the one or more network interfaces 210 include wireless and/or wired interfaces for receiving data from and/or transmitting data to other electronic devices 102, a media content server 104, a CDN 106, and/or other devices or systems. In some embodiments, data communications are carried out using any of a variety of custom or standard wireless protocols (e.g., NFC, RFID, IEEE 802.15.4, Wi-Fi, ZigBee, 6LoWPAN, Thread, Z-Wave, Bluetooth, ISA100.11a, WirelessHART, MiWi, etc.). Furthermore, in some embodiments, data communications are carried out using any of a variety of custom or standard wired protocols (e.g., USB, Firewire, Ethernet, etc.). For example, the one or more network interfaces 210 include a wireless interface 260 for enabling wireless data communications with other electronic devices 102, and/or or other wireless (e.g., Bluetooth-compatible) devices (e.g., for streaming audio data to the electronic device 102 of an automobile). Furthermore, in some embodiments, the wireless interface 260 (or a different communications interface of the one or more network interfaces 210) enables data communications with other WLAN-compatible devices (e.g., electronic device(s) 102) and/or the media content server 104 (via the one or more network(s) 112, FIG. 1).

In some embodiments, electronic device 102 includes one or more sensors including, but not limited to, accelerometers, gyroscopes, compasses, magnetometer, light sensors, near field communication transceivers, barometers, humidity sensors, temperature sensors, proximity sensors, range finders, and/or other sensors/devices for sensing and measuring various environmental conditions.

Memory 212 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 212 may optionally include one or more storage devices remotely located from the CPU(s) 202. Memory 212, or alternately, the non-volatile memory solid-state storage devices within memory 212, includes a non-transitory computer-readable storage medium. In some embodiments, memory 212 or the non-transitory computer-readable storage medium of memory 212 stores the following programs, modules, and data structures, or a subset or superset thereof:
an operating system 216 that includes procedures for handling various basic system services and for performing hardware-dependent tasks;
network communication module(s) 218 for connecting the electronic device 102 to other computing devices (e.g., other electronic device(s) 102, and/or media content server 104) via the one or more network interface(s) 210 (wired or wireless) connected to one or more network(s) 112;
a user interface module 220 that receives commands and/or inputs from a user via the user interface 204 (e.g., from the input devices 208) and provides outputs for playback and/or display on the user interface 204 (e.g., the output devices 206);
a media application 222 (e.g., an application for accessing a media-providing service of a media content provider associated with media content server 104) for uploading, browsing, receiving, processing, presenting, and/or requesting playback of media (e.g., media items). In some embodiments, media application 222 includes a media player, a streaming media application, and/or any other appropriate application or component of an application. In some embodiments, media application 222 is used to monitor, store, and/or transmit (e.g., to media content server 104) data associated with user behavior. In some embodiments, media application 222 also includes the following modules (or sets of instructions), or a subset or superset thereof:
   a media content selection module 224 for selecting one or more media content items and/or sending, to the media content server, an indication of the selected media content item(s);
   a media content browsing module 226 for providing controls and/or user interfaces enabling a user to navigate, select for playback, and otherwise control or interact with media content, whether the media content is stored or played locally or remotely;
   a content items module 228 for processing uploaded media items and storing media items for playback and/or for forwarding to the media content server;
   a list generation module 230 for generating one or more lists of media content items, including determining, filtering and/or ranking media content items for the one or more lists; and
   a user data module 232 for determining and/or storing user data (e.g., a playback history of the user and/or a user profile indicating demographics and/or preferences of a user);
a physical parameter measurement application 234 for measuring and/or receiving an indication of one or more physical parameters (e.g., heart rate, blood pressure, body temperature, etc.) of a user; and
other applications 236, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support.

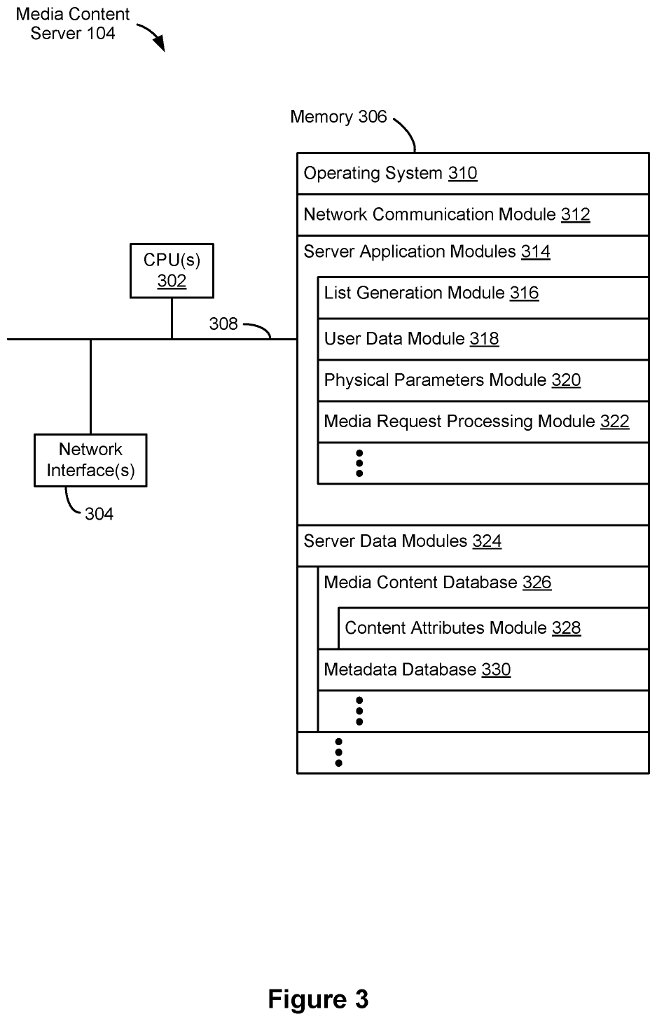

FIG. 3 is a block diagram illustrating a media content server 104, in accordance with some embodiments. The media content server 104 typically includes one or more central processing units/cores (CPUs) 302, one or more network interfaces 304, memory 306, and one or more communication buses 308 for interconnecting these components.

Memory 306 includes high-speed random access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. Memory 306 optionally includes one or more storage devices remotely located from one or more CPUs 302. Memory 306, or, alternatively, the non-volatile solid-state memory device(s) within memory 306, includes a non-transitory computer-readable storage medium. In some embodiments, memory 306, or the non-transitory computer-readable storage medium of memory 306, stores the following programs, modules and data structures, or a subset or superset thereof:
an operating system 310 that includes procedures for handling various basic system services and for performing hardware-dependent tasks;
a network communication module 312 that is used for connecting the media content server 104 to other computing devices via one or more network interfaces 304 (wired or wireless) connected to one or more networks 112;
one or more server application modules 314 for performing various functions with respect to providing and managing a content service, the server application modules 314 including, but not limited to, one or more of:
   a list generation module 316 for generating one or more lists of media content items, including determining, filtering and/or ranking media content items for the one or more lists;
   a user data module 318 for determining and/or storing user data (e.g., a playback history of the user and/or a user profile indicating demographics and/or preferences of a user);
   a physical parameters module 320 for processing and/or receiving an indication of one or more physical parameters (e.g., heart rate, blood pressure, body temperature, etc.) of a user;
   a media request processing module 322 for processing requests for media content and facilitating access to requested media items by electronic devices (e.g., the electronic device 102) including, optionally, streaming media content to such devices;
one or more server data module(s) 324 for handling the storage of and/or access to media items and/or metadata relating to the media items; in some embodiments, the one or more server data module(s) 324 include:
   a media content database 326 for storing media items, including, but not limited to, one or more of:
      content attributes module 328 for storing values for one or more attributes (e.g., characteristics and/or emotional tags) that describe a respective content item; and
   a metadata database 330 for storing metadata relating to the media items.

In some embodiments, the media content server 104 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), XHP, Javelin, Wireless Universal Resource File (WURFL), and the like.

Each of the above identified modules stored in memory 212 and 306 corresponds to a set of instructions for performing a function described herein. The above identified modules or programs (i.e., sets of instructions) need not be implemented as separate software programs, procedures, or modules, and thus various subsets of these modules may be combined or otherwise re-arranged in various embodiments. In some embodiments, memory 212 and 306 optionally store a subset or superset of the respective modules and data structures identified above. Furthermore, memory 212 and 306 optionally store additional modules and data structures not described above. In some embodiments, memory 212 stores one or more of the above identified modules described with regard to memory 306. In some embodiments, memory 306 stores one or more of the above identified modules described with regard to memory 212.

Although FIG. 3 illustrates the media content server 104 in accordance with some embodiments, FIG. 3 is intended more as a functional description of the various features that may be present in one or more media content servers than as a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. In some embodiments, media content database 326 and/or metadata database 330 are stored on devices (e.g., CDN 106) that are accessed by media content server 104. The actual number of servers used to implement the media content server 104, and how features are allocated among them, will vary from one implementation to another and, optionally, depends in part on the amount of data traffic that the server system handles during peak usage periods as well as during average usage periods.

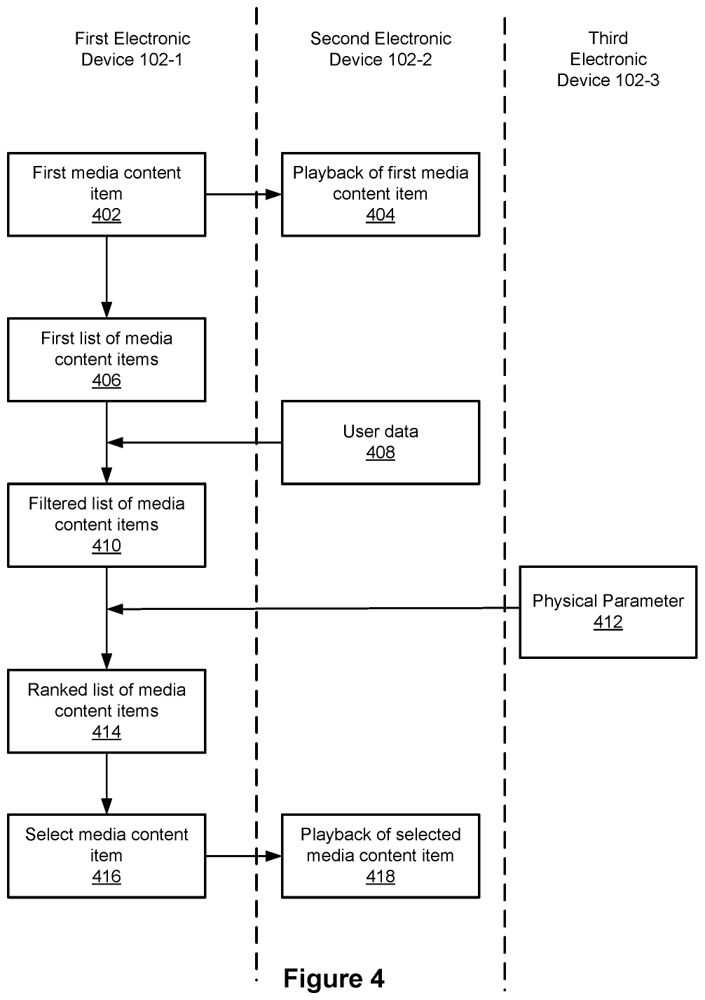

FIG. 4 illustrates a method for selecting a media content item based on user data and a physical parameter. While particular steps are shown as occurring at a first electronic device 102-1, a second electronic device 102-2, and a third electronic device 102-3, one of ordinary skill in the art will understand that all of the steps may be performed by a single electronic device (e.g., first electronic device 102-1). Alternatively, one of skill in the art will understand that certain steps shown, for example, as being performed by third electronic device 102-3 may be performed by second electronic device 102-2.

In some embodiments, a first media content item 402 is selected at a first electronic device 102-1. In some embodiments, the first electronic device 102-1 is a mobile device. In some embodiments, the first electronic device 102-1 is a server (e.g., media content server 104). The first media content item 402 is selected from content items module 228. In some embodiments, a user selects (e.g., using media content selection module 224) the first media content item 402. In some embodiments, the first media content item 402 is selected without user input (e.g., automatically) by the electronic device 102. For example, the first media content item 402 comprises a song in a playlist that is automatically presented (e.g., streamed) to the user. In some embodiments, the first media content item is played back (404) at a second electronic device 102-2 (e.g., that is distinct from the first electronic device 102-1). For example, the first media content item is currently being presented to the user (e.g., at an electronic device). In some embodiments, the first media content item 402 is played back at the same electronic device that selects the first media content item (e.g., first electronic device 102-1).

In some embodiments, the first electronic device 102-1 generates (e.g., using list generation module 230) a first list of media content items 406. For example, the first electronic device 102-1 generates a list of media content items that are related to the first media content item. In some embodiments, the first list of media items is a content-based list of media items that is independent of the user (e.g., not personalized to the user or any particular user). The first list of media content items includes content items that are similar to the first media content item. For example, the first list of media content items comprises a streaming “radio station” that is based on a song (e.g., the first content item), an album, an artist, or a genre. In some embodiments, the similarity between respective media content items is based on a closeness in vector space between the respective media content items. In some embodiments, a machine learning algorithm is used to determine similar media content items.

In some embodiments, the similarity between respective media content items is based on metadata (e.g., manual tagging) associated with the respective media content items. For example, when two media content items share one or more metadata tags (e.g., or have close values for one or more metadata tags), the two media content items are considered similar.

In some embodiments, the similarity between respective media content items is based on how often the respective media content items are streamed closely in time with respect to each other (e.g., based on a frequency at which the respective media content items are streamed within a predefined period of time). For example, if two media content items are often provided to a same user within a time period (e.g., within 5 songs of each other and/or within 20 minutes of each other), then the two media content items are determined to be similar (e.g., classified as similar).

In some embodiments, a respective media content item is assigned a similarity score (e.g., with respect to the first media content item) based on one or more of the above methods of determining similarity.

In some embodiments, the first list comprises a predetermined number of media content items. For example, the first list comprises 1000 media content items (e.g., selected from content items module 228) that are determined to be the most similar (e.g., based on their respective similarity scores) to the first media content item.

In some embodiments, the first electronic device 102-1 receives user data 408. For example, user data 408 includes information about the user that is stored by the user profile, such as demographic information about the user (e.g., age, gender, geographic location, etc.) and/or a playback history of the user. For example, the playback history of the user includes media content items that have previously (e.g., within a time period) been provided to the user by the media-providing service. In some embodiments, the user data 408 is used to determine preferences of the user (e.g., characteristics of media content items that the user is likely to prefer).

In some embodiments, the first electronic device 102-1 uses the user data 408 to filter the first list of media content items (410) (e.g., filters the first list of media content items based on the user data 408) to generate a second list of media content items. In some embodiments, filtering the first list of media content items includes determining (e.g., using the user data 408) media content items that match the user's taste (e.g., based on the user's playback history and/or demographic information). For example, the first electronic device 102-1 filters the list of media content items that are related to the first media content item to include the media content items that satisfy characteristics based on the user data 408. In some embodiments, the first electronic device 102-1 filters the first list to remove media content items from the first list that are not consistent with the user data. For example, the first list of media content items that are similar to the first media content item is filtered to include media content items that also reflect the user's preferences (e.g., based on the user data).

In some embodiments, the first list of media content items is filtered using a machine learning algorithm. For example, the machine learning algorithm determines (e.g., using collaborative filtering) media content items that match the user's taste (e.g., based on the user's playback history and/or demographic information).

In some embodiments, the filtered list (e.g., the second list of media content items) includes approximately a quarter to a third of the number of media content items as the first list. For example, the first list includes 1000 candidate media content items, while the filtered list includes between 250 to 300 media content items. In some embodiments, the second list of media items is a user-based list of media items (e.g., personalized to the specific user).

In some embodiments, a third electronic device 102-3 (e.g., a wearable device, such as a smart watch) measures a physical parameter 412. For example, the wearable device measures the user's pulse, blood pressure, body temperature, and/or ambient temperature of the user. In some embodiments, the third electronic device 102-3 provides a value of the physical parameter to the first electronic device 102-1.

In some embodiments, the first electronic device 102-1 receives a value of a physical parameter 412 and, based on the physical parameter, generates a ranked list of media content items 414. For example, the first electronic device ranks the media content items in the filtered list of media content items 410, where the ranking is based on a similarity between the media content item in the filtered list and the value of the physical parameter 412.

For example, the value of the physical parameter indicates (e.g., is mapped to) an emotional tag (e.g., a mood) that represents a current state of the user. In some circumstances, the emotional tag is distinct and separate from the physical parameter. In some embodiments, a value of the physical parameter is mapped to the emotional tag. For example, a heart rate (physical parameter) may be mapped to “excitement” (an emotional tag) when a value of the heart rate is high whereas the heart rate may be mapped to “mellow” when the value of the heart rate is low. In some embodiments, mapping the value of the physical parameter to emotional tag includes comparing the value of the physical parameter to a baseline (e.g., a baseline specific to the user based on historical (e.g., prior) measured values for the physical parameter from the user and/or a baseline based on historical (e.g., prior) measured values for the physical parameter from a cohort of people in sharing one or more of the user's demographics (e.g., age, sex)).

In some embodiments, each of the media content items in the filtered list includes one or more emotional tags (e.g., and/or values corresponding to each of the emotional tags). The ranked list of media content items reorders the media content items on the filtered list that are most similar to the indicated emotional tag (e.g., based on the physical parameter) at the top of the ranked list and the media content items that are least similar to the indicated emotional tag at the bottom of the ranked list.

In some embodiments, each media content item is associated with a value of a physical parameter (e.g., the values for the physical parameters are examples of the respective attributes described with respect to method 500) (e.g., the media content items in the filtered list include metadata that indicates how the physical parameter relates to each media content item). For example, each media content item is associated with a value of a pulse (e.g., heart rate). In some embodiments, the first electronic device 102-1 receives a value of the user's pulse (e.g., from the wearable device) and ranks (reorders) the media content items in the filtered list based on the difference between the value of the user's pulse and the value of the pulse that is associated with each respective media content item. The media content item associated with a value of a pulse that is closest to the user's pulse is ranked highest.

In some embodiments, the first electronic device 102-1 selects a media content item 416 (e.g., a next media content item) from the ranked list of media content items 414. In some embodiments, the top-ranked media content item in the ranked list is selected and provided for playback (418) at the second electronic device 102-2. For example, the media content item associated with the value of a pulse that is closest to the value of the user's pulse is selected because it is at the top of the ranked list. Thus, in some embodiments, the first electronic device 102-1 selects the next media content item based on both personalization of a list of media content items (e.g., personalization of a playlist) and a value of a physical parameter obtained from the user at or near the time that the next media item is selected.

In some embodiments, the steps explained above are performed (e.g., repeated) for the selected media content item (e.g., instead of the first media content item) to determine and select a next media content item for the user. As the user continues to consume the media content items provided, the system continues to receive user data and/or the physical parameter of the user in order to continue providing recommendations the reflect a similarity to the currently streamed media content item and the current state of the user. In some embodiments, the third electronic device 102-3 continues providing (e.g., updating) values of the physical parameter(s) to the first electronic device 102-1. In some embodiments, the first electronic device 102-1 selects a subsequent media item (e.g., from the second list of media items) based on the updated value of the physical parameters (e.g., in an analogous manner to the description of the selection of the media item, described above).

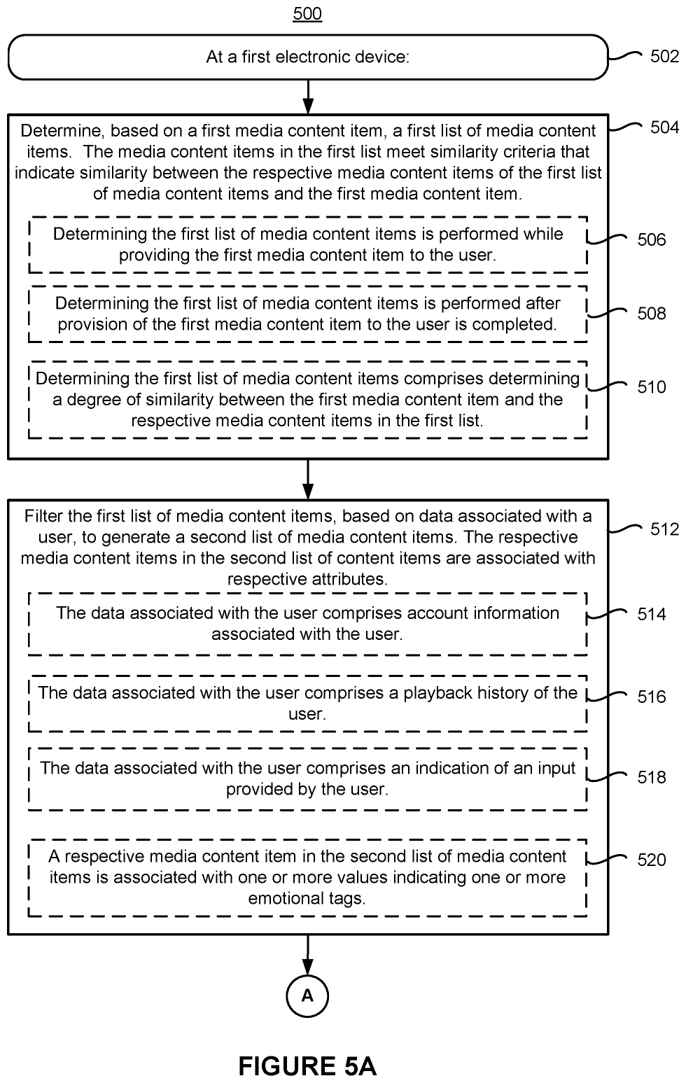

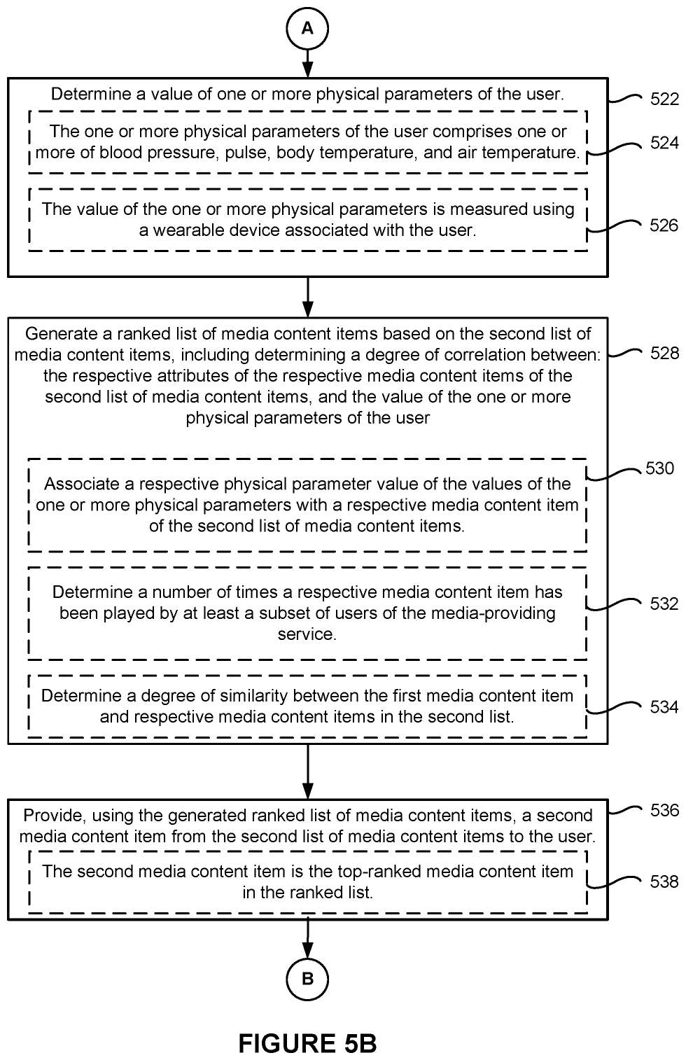

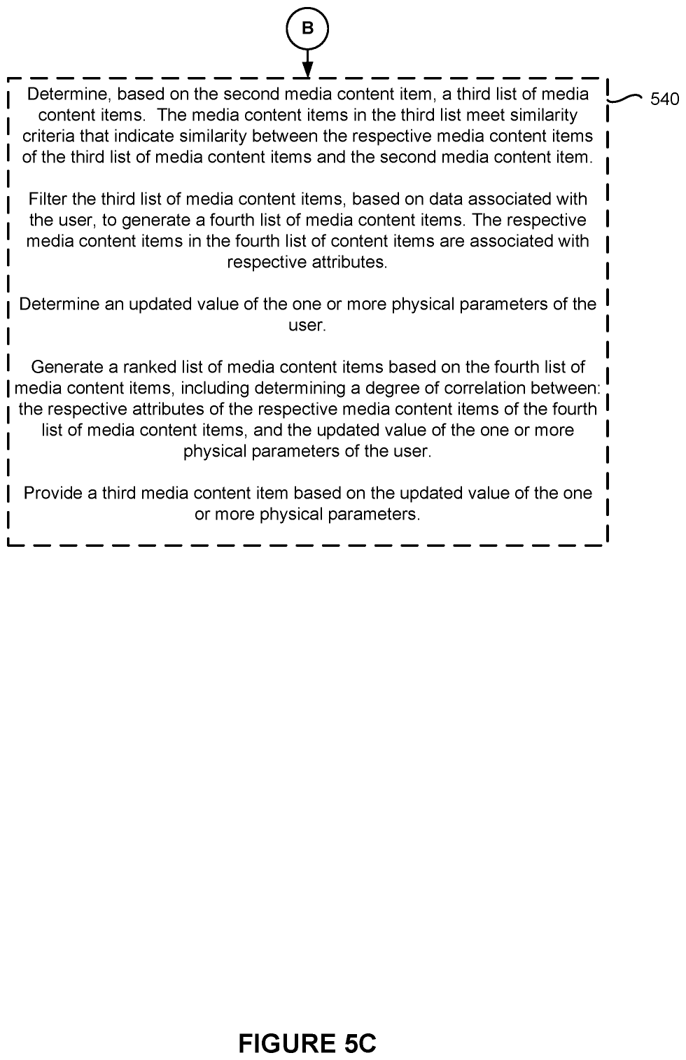

FIGS. 5A-5C are flow diagrams illustrating a method 500 for modifying a media content item, in accordance with some embodiments. Method 500 may be performed (502) at a first electronic device (e.g., media content server 104), the electronic device having one or more processors and memory storing instructions for execution by the one or more processors. In some embodiments, the method 500 is performed by executing instructions stored in the memory (e.g., memory 212, FIG. 2) of the electronic device. In some embodiments, the method 500 is performed by an electronic device 102-1. In some embodiments, the method 500 is performed by a combination of the server system (e.g., including media content server 104 and/or CDN 106) and an electronic device (e.g., electronic device 102-1).

Referring now to FIG. 5A, in performing the method 500, the first electronic device determines (504), based on a first media content item (e.g., that is currently provided to the user), a first list of media content items (e.g., the first list of media content items 406). The media content items in the first list meet similarity criteria that indicate similarity between the respective media content items of the first list of media content items and the first media content item.

In some embodiments, determining the first list of media content items is performed (506) while providing the first media content item to the user. For example, the first list of media content items is generated while the first media content item is playing back.

In some embodiments, determining the first list of media content items is performed (508) after provision of the first media content item to the user is completed. For example, the first list of media content items is generated at the end of the media content item, when playback (e.g., streaming) of the first media content item is finished.

In some embodiments, determining the first list of media content items is performed before providing the first media content item to the user.

In some embodiments, determining the first list of media content items comprises determining (510) (e.g., using a neural network) a degree of similarity between the first media content item and the respective media content items in the first list. For example, the media content items are selected (e.g., from content items module 228) based on a similarity between the first media content item and the other media content items. In some embodiments, the similarity between respective media content items is based on a closeness of the media content items in a vector space. In some embodiments, the similarity between respective media content items is based on the respective media content items appearing in a same playlist.

The electronic device filters (512) the first list of media content items, based on data associated with a user, to generate a second list of media content items (e.g., a list of candidate media content items). For example, the user data 408 includes information about a playback history of the user, input received from the user, and/or account (e.g., profile) information associated with the user. The respective media content items in the second list of media content items are associated with respective attributes (e.g., emotional tags, values of physical parameters, metadata tags, etc., as described above). In some embodiments, the second list of media content items comprises the filtered list of media content items 410 (FIG. 4).

In some embodiments, the data associated with the user comprises (514) account information associated with the user. For example, the account information includes demographic information about the user (e.g., that is provided by the user) and/or user settings for the account.

In some embodiments, the data associated with the user comprises (516) a playback history of the user.

In some embodiments, the data associated with the user comprises (518) an indication of an input provided by the user. For example, the data associated with the user comprises indications of a user input for skipping a media content item (e.g., to stop playback of the media content item) that is received while the media content item is playing. In some embodiments, the input provided by the user comprises the user indicating a preference for the media content item (e.g., by “liking,” “starring” or adding as a “favorite” the media content item).

In some embodiments, a respective media content item in the second list of media content items is associated (520) with one or more values indicating one or more emotional tags (e.g., the emotional tags are examples of the respective attributes). For example, each media content item in the filtered list of media content items is associated with values for one or more emotional tags (e.g., moods). In some embodiments, the one or more values indicate a degree of correspondence (e.g., similarity) between respective emotional tags in a set of emotional tags and a respective content item (e.g., the first media content item).

The electronic device determines (522) a value of one or more physical parameters of the user.

In some embodiments, the one or more physical parameters of the user comprise (524) one or more of blood pressure, pulse (e.g., heart rate), body temperature, and air temperature. In some embodiments, the one or more physical parameters includes a respiratory rate.

In some embodiments, the value of the one or more physical parameters is measured (526) using a wearable device associated with the user. For example, as shown in FIG. 4, the third electronic device 102-3 sends the value of the one or more physical parameters 412 to the first electronic device.

The electronic device generates (528) a ranked list of media content items based on the second list of media content items, including determining a degree of correlation between the respective attributes of the respective media content items of the second list of media content items, and the value of the one or more physical parameters of the user. For example, the value of the one or more physical parameters correlates to an attribute and the respective media items are associated with respective attributes. The ranking is based on how closely the value of the physical parameters match the attributes for a respective media item. In some embodiments, the ranked list includes the same media content items in the second list (e.g., the ranked list is a reordered version of the second list).

In some embodiments, generating the ranked list of media content items includes associating (530) (e.g., using a machine learning algorithm) a respective physical parameter value of the values of the one or more physical parameters with a respective media content item of the second list of media content items. For example, as described with reference to FIG. 4, the filtered list is ranked based on values of one or more emotional tags associated with the respective media content items to match the respective media content items with a value of the physical parameter.

In some embodiments, generating the ranked list of media content items comprises (532) determining a number of times a respective media content item has been played, within a predefined period of time, by at least a subset of users of the media-providing service. For example, the list is ranked based on a popularity of the media content item. In some embodiments, the number of times corresponds to a total number of times the respective media content item has been played across all users of the media-providing service.

In some embodiments, generating the ranked list of media content items comprises (534) determining a degree of similarity between the first media content item and respective media content items in the second list. For example, the ranking (e.g., reordering) is performed using methods explained for determining similarity between two media content items as described with reference to FIG. 4 such that the most similar items are ranked the highest.

The electronic device provides (e.g., identifies) (536), using the ranked list of media content items (e.g., the generated ranked list), a second media content item from the second list of media content items to the user. In some embodiments, the electronic device initiates playback of the second media content item at the first electronic device without additional input from the user. This improves the processing power of the electronic device by reducing the number of user inputs required for another content item to be presented to the user. In some embodiments, the electronic device transmits, from the first electronic device to a second electronic device, the second media item to be played back at the second electronic device (e.g., as shown in FIG. 4).

In some embodiments, the second media content item is (538) the top-ranked media content item in the ranked list.

In some embodiments, after providing the second media content item to the user, the electronic device determines (540), based on the second media content item, a third list of media content items. The media content items in the third list meet similarity criteria that indicate similarity between the respective media content items of the third list of media content items and the second media content item. In some embodiments, the electronic device filters the third list of media content items, based on data associated with the user, to generate a fourth list of media content items (e.g., a list of candidate media content items), wherein the respective media content items in the fourth list of content items are associated with respective attributes. In some embodiments, the electronic device determines an updated value of the one or more physical parameters of the user. In some embodiments, the electronic device generates a ranked list of media content items based on the fourth list of media content items, including determining a degree of correlation between: the respective attributes of the respective media content items of the fourth list of media content items, and the updated value of the one or more physical parameters of the user. In some embodiments, the electronic device provides a third media content item based on the updated value of the one or more physical parameters. For example, the first electronic device provides another recommendation (e.g., the third media content item) by performing the same process used to determine the second media content item. In some embodiments, the provided media content items (e.g., recommendations) are updated with each media content item (e.g., most recent content item that is playing back) to reflect a current state (e.g., mood) of the user.

In some embodiments, instead of performing all of the steps to identify the third media content item, the second list remains the same (e.g., as when determining the second media content item), another ranked list is generated (e.g., where the rankings are updated to reflect an updated physical parameter received from the user), and the third media content item is selected from the new ranked list. For example, the electronic device determines an updated value of the one or more physical parameters of the user, generates a ranked list of media content items based on the second list of media content items, including determining a degree of correlation between: the respective attributes of the respective media content items of the second list of media content items, and the updated value of the one or more physical parameters of the user. The electronic device provides the third media content item based on the updated value of the one or more physical parameters

Although FIGS. 5A-5C illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best utilize the embodiments and various embodiments with various modifications as are suited to the particular use contemplated.

1. A method, comprising:
at a first electronic device associated with a media-providing service, the first electronic device having one or more processors and memory storing instructions for execution by the one or more processors:
determining, based on a first media content item, a first list of media content items, wherein the media content items in the first list meet similarity criteria that indicate similarity between the respective media content items of the first list of media content items and the first media content item;
filtering the first list of media content items, based on a playback history of a user, to generate a second list of media content items, wherein the respective media content items in the second list of media content items are associated with respective attributes;
determining a current value of one or more physical parameters of the user;
after determining the current value of the one or more physical parameters of the user, reordering media content items within the second list of media content items to generate a ranked list, wherein the reordering is based on:
the respective attributes of the respective media content items of the second list of media content items, and
the current value of the one or more physical parameters of the user; and
providing, using the ranked list of media content items, a second media content item from the second list of media content items to the user.

2. The method of claim 1, wherein determining the first list of media content items is performed while providing the first media content item to the user.

3. The method of claim 1, wherein determining the first list of media content items is performed after provision of the first media content item to the user is completed.

4. The method of claim 1, wherein determining the first list of media content items is performed before providing the first media content item to the user.

5. The method of claim 1, wherein the one or more physical parameters of the user comprises one or more of blood pressure, pulse, body temperature, and air temperature.

6. The method of claim 1, wherein the current value of the one or more physical parameters is measured using a wearable device associated with the user.

7. The method of claim 1, wherein reordering the media content items within the second list of media content items is further based on associating a respective physical parameter value of the values of the one or more physical parameters with a respective media content item of the second list of media content items.

8. The method of claim 1, wherein determining the first list of media content items comprises determining a degree of similarity between the first media content item and the respective media content items in the first list.

9. The method of claim 1, wherein the first list of media content items is further filtered based on account information associated with the user.

10. (canceled)

11. The method of claim 1, wherein the first list of media content items is further filtered based on an indication of an input provided by the user.

12. The method of claim 1, wherein reordering the media content items within the second list of media content items is further based on a number of times a respective media content item has been played, within a predefined period of time, by at least a subset of users of the media-providing service.

13. The method of claim 1, wherein reordering the media content items within the second list of media content items is further based on a degree of similarity between the first media content item and respective media content items in the second list.

14. The method of claim 1, wherein a respective media content item in the second list of media content items is associated with one or more values indicating one or more emotional tags.

15. The method of claim 1, further comprising, after providing the second media content item to the user:
determining, based on the second media content item, a third list of media content items, wherein the media content items in the third list meet similarity criteria that indicate similarity between the respective media content items of the third list of media content items and the second media content item;
filtering the third list of media content items, based on data associated with the user, to generate a fourth list of media content items, wherein the respective media content items in the fourth list of content items are associated with respective attributes;
determining an updated value of the one or more physical parameters of the user;
generating a ranked list of media content items based on the fourth list of media content items, including determining a degree of correlation between:
the respective attributes of the respective media content items of the fourth list of media content items, and
the updated value of the one or more physical parameters of the user; and
providing a third media content item based on the updated value of the one or more physical parameters.

16. The method of claim 1, wherein the second media content item is the top-ranked media content item in the ranked list.

17. A first electronic device, comprising:
one or more processors; and
memory storing instructions for execution by the one or more processors, the instructions including instructions for:
determining, based on a first media content item, a first list of media content items, wherein the media content items in the first list meet similarity criteria that indicate similarity between the respective media content items of the first list of media content items and the first media content item;
filtering the first list of media content items, based on a playback history of a user, to generate a second list of media content items, wherein the respective media content items in the second list of media content items are associated with respective attributes;
determining a current value of one or more physical parameters of the user;
after determining the current value of the one or more physical parameters of the user, reordering media content items within the second list of media content items to generate a ranked list, wherein the reordering is based on:
the respective attributes of the respective media content items of the second list of media content items, and
the current value of the one or more physical parameters of the user; and
providing, using the ranked list of media content items, a second media content item from the second list of media content items to the user.

18. A non-transitory computer-readable storage medium storing instructions, which when executed by a first electronic device, cause the first electronic device to:
determine, based on a first media content item, a first list of media content items, wherein the media content items in the first list meet similarity criteria that indicate similarity between the respective media content items of the first list of media content items and the first media content item;
filter the first list of media content items, based on a playback history of a user, to generate a second list of media content items, wherein the respective media content items in the second list of media content items are associated with respective attributes;
determine a current value of one or more physical parameters of the user;
after determining the current value of the one or more physical parameters of the user, reorder media content items within the second list of media content items to generate a ranked list, wherein the reordering is based on:
the respective attributes of the respective media content items of the second list of media content items, and
the current value of the one or more physical parameters of the user; and
provide, using the ranked list of media content items, a second media content item from the second list of media content items to the user.
